(19) United States
(12) Patent Application Publication
(10) Pub. No.: US 2024/0054515 A1
(43) Pub. Date: Feb. 15, 2024

(54) SYSTEM AND METHOD FOR FORECASTING COMMODITIES AND MATERIALS FOR PART PRODUCTION

(71) Applicant: Resilinc Corporation, Milpitas, CA (US)

(72) Inventors: Siddharth Subramanian, Milpitas, CA (US); Sumit Vakil, Milpitas, CA (US); Shahzaib Khan, Milpitas, CA (US); Rushikesh Kanwa, Milpitas, CA (US)

(21) Appl. No.: 18/447,711

(22) Filed: Aug. 10, 2023

Related U.S. Application Data
(60) Provisional application No. 63/396,869, filed on Aug. 10, 2022.

(51) Int. Cl. G06Q 30/0201; G06Q 10/0875; G06Q 10/0637

(52) U.S. Cl. CPC G06Q 30/0206; G06Q 10/0875; G06Q 10/06375

(57) ABSTRACT

A method and system to predict the cost of a product. Materials necessary to manufacture a product are determined. Data related to the price of each of the materials required for the product over a predetermined period of time is collected. The price of each of the materials at a future time is predicted based on the collected data via a set of models. The prices are aggregated to determine the aggregate predicted cost of the product at a period of time in the future. A recommendation of materials to meet a future demand based on the predicted cost is determined.

### PRIORITY CLAIM

The present disclosure claims benefit of and priority to U.S. Provisional No. 63/396,869, filed Aug. 10, 2022. The contents of that application are hereby incorporated by reference in their entirety.

### TECHNICAL FIELD

The present disclosure generally relates to a system and method for prediction of a supply and cost of materials for the manufacture of a part.

### BACKGROUND

The availability and price fluctuations of raw materials can significantly affect profitability and ability to meet consumer demands for manufactured products. Monitoring news sources for updates on geopolitical events, supply chain disruptions, natural disasters, and trade policies can provide valuable insights into potential raw material shortages or price hikes, but are difficult to synthesize into useful data.

By staying informed about these trends, businesses can make proactive decisions to secure alternative suppliers, negotiate better contracts, or adjust product formulations to adapt to changing availability of raw materials. However, there is no process that can provide a supply or price prediction for all significant materials in a product incorporating diverse data such as public sentiment surrounding their products, competitors, and the industry as a whole.

Thus, there is need for a predictive system that allows automatic efficient ordering of component materials for manufacturing a product. There is a need for a system that bases predictions of supply and price on both quantitative and qualitative models. There is a need for a system that aggregates data on all component materials to predict demand for a product.

### SUMMARY

The term embodiment and like terms are intended to refer broadly to all of the subject matter of this disclosure and the claims below. Statements containing these terms should be understood not to limit the subject matter described herein or to limit the meaning or scope of the claims below. Embodiments of the present disclosure covered herein are defined by the claims below, not this summary. This summary is a high-level overview of various aspects of the disclosure and introduces some of the concepts that are further described in the Detailed Description section below. This summary is not intended to identify key or essential features of the claimed subject matter; nor is it intended to be used in isolation to determine the scope of the claimed subject matter. The subject matter should be understood by reference to appropriate portions of the entire specification of this disclosure, any or all drawings and each claim.

One disclosed example is a method of predicting pricing of a product. Data related to the price of each of a plurality of materials required for the product over a predetermined period of time is collected. The price of each of the materials at a future time is predicted by inputting the collected data to a plurality of models executed by a processor. The predicted changes in prices of the plurality of materials is aggregated to determine the aggregated predicted cost of the product at a period of time in the future. A recommendation of obtaining materials to meet a future demand based on the predicted aggregated changes in prices is obtained.

In another disclosed implementation of the example method, each of the plurality of models includes a qualitative model analyzing qualitative data inputs and a quantitative model analyzing quantitative data input. In another disclosed implementation, the analyzing quantitative data includes applying a natural language process to the text of news articles to determine an effect on the predicted price. In another disclosed implementation, the prediction outputs include availability of each of the plurality of materials. In another disclosed implementation, the example method includes deconstructing the product into the different plurality of materials. In another disclosed implementation, an aggregated product cost is determined by determining the weight of each of the materials based on predicted material cost. In another disclosed implementation, the example method includes automatic communication of an order for at least one of the materials based on the recommendation. In another disclosed implementation, the example method includes ranking the plurality of materials by influence on the product production. In another disclosed implementation, the example method includes scheduling a manufacturing system to produce the product based on the resulting output. In another disclosed implementation, the example method includes displaying on a display an interface with the predicted prices of each of the plurality of materials and providing a communication input to contact a supplier of at least one of the plurality of materials.

Another disclosed example is a system that has a memory and a controller including one or more processors. The controller is operable to determine a plurality of materials necessary to manufacture a product. The controller collects data related to the price of each of a plurality of materials required for the product over a predetermined period of time. The controller predicts the price of each of the plurality of materials at a future time based on the collected data via a plurality of models. The controller aggregates the prices to determine the aggregate predicted cost of the product at a period of time in the future. The controller produces a recommendation of the materials to meet a future product demand based on the predicted cost.

In another disclosed implementation of the example system, each of the plurality of models includes a qualitative model analyzing qualitative data inputs and a quantitative model analyzing quantitative data inputs. In another disclosed implementation, analyzing quantitative data inputs includes applying a natural language processor to the text of news articles to determine an effect on the predicted price. In another disclosed implementation, the prediction outputs include availability of each of the plurality of materials. In another disclosed implementation, an aggregated product cost is determined by determining the weight of each of the materials based on predicted material cost. In another disclosed implementation, the example system includes an interface coupled to a supply system, wherein the controller is operable to automatically communicate an order on the interface for at least one of the materials based on the recommendation. In another disclosed implementation, the controller is operable to rank the plurality of materials by influence on the product production. In another disclosed implementation, the example system includes a manufacturing system coupled to the controller. The controller is operable to schedule the manufacturing system to produce the product based on the recommendation. In another disclosed implementation, the example system includes a display coupled to the controller. The controller is operable to display an interface with the predicted prices of each of the plurality of materials and provide a communication input to contact a supplier of at least one of the plurality of materials.

Another disclosed example is a non-transitory computer-readable medium having machine-readable instructions stored thereon. The instructions when executed by a processor, cause the processor to determine a plurality of materials necessary to manufacture a product. The instructions cause the processor to collect data related to the price of each of a plurality of materials required for the product over a predetermined period of time. The instructions cause the processor to predict the price of each of the plurality of materials at a future time based on the collected data via a plurality of models. The instructions cause the processor to aggregate the prices to determine the aggregate predicted cost of the product at a period of time in the future. The instructions cause the processor to produce a recommendation of the materials to meet a future product demand based on the predicted cost.

### DESCRIPTION OF DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrated only typical embodiments of this disclosure and are therefore not to be considered limiting of its scope, for the disclosure may admit to other equally effective embodiments.

FIG. 1 is a block diagram illustrating the example system used in a manufacturing process, according to example embodiments.

FIG. 2 is a block diagram showing the example automated system of predicting material availability and price, according to example embodiments.

FIG. 3 shows an example model for prediction of price and contribution in FIG. 2;

FIG. 4 shows an example screen image of an output from an example qualitative model in FIG. 2;

FIG. 5 is a table of example features used in an example model for forecasting a commodity;

FIG. 6 is an example graph showing the results of results of principal component analysis applied to the example model in FIG. 5;

FIGS. 7A-7C show charts that rank features for the example model;

FIG. 8A is a graph of the attribution of custom features in an example forecast model;

FIG. 8B is a chart describing the performance of an example 3 month model;

FIG. 8C is a chart describing the performance of an example 6 month model;

FIG. 9 is an example screen image of an output display produced by the process in FIG. 2;

FIG. 10 is an example set of price forecasts for the materials required by a product; and

FIGS. 11-12 are an example computing system.

### DETAILED DESCRIPTION

Aspects of the invention will be apparent to those of ordinary skill in the art in view of the detailed description of various embodiments, which is made with reference to brief description provided herein.

The present disclosure relates to a system and method to forecast material supplies and costs for production of products. The example system is a computer-automated method of mapping raw material price forecast and predicted availability fluctuations for a specific part or stock keeping unit (SKU). Utilizing the customer's bill of materials (BoM) data on a platform, such as that offered by Resilinc, the example system and method identifies materials used in customer part composition and maps material forecasts to customer parts. Once an aggregated materials forecast is linked to customer part, fluctuations in the prices of materials/compositions used in parts and availability projections may be tracked. A user may also receive insights such as buying or holding the material around material cost projections derived for the part/SKU. Once the availability and price forecasts of materials are mapped to customer parts/SKUs, a cost projection is derived for the parts/SKUs and components.

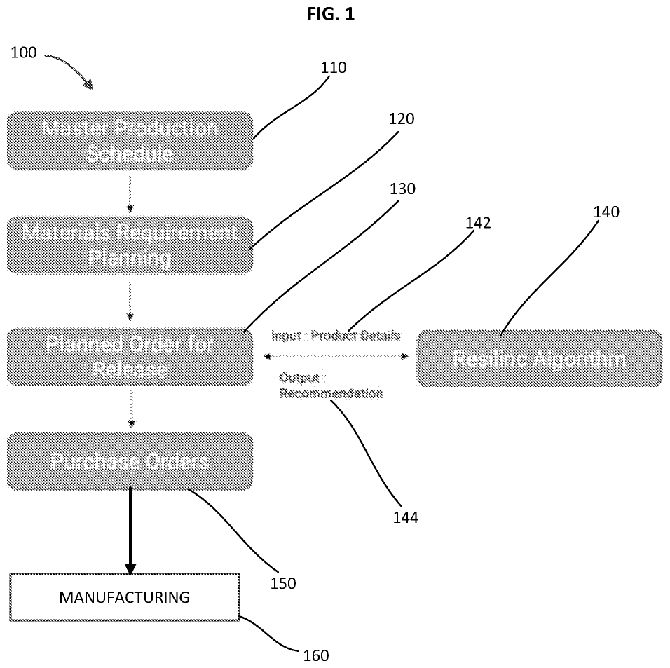

FIG. 1 shows an example process 100 for production of products. A master production schedule 110 is established. The master production schedule 110 includes all the timing of systems such as manufacturing systems for manufacturing a part. A materials requirement plan 120 is established in order to determine the materials required by the production schedule 110. An order for release of the planed products 130 integrates the materials and the production schedule 110. An example prediction system 140 takes inputs of the product details in terms of material requirements 142. The prediction system 140 outputs recommendation data 142 for the timing of purchasing the required materials based on predicted supply and predicted price of the materials and the cost projection for the overall product. An automated purchase system 150 may then be employed to purchase the materials for a manufacturing system 160 to produce the products.

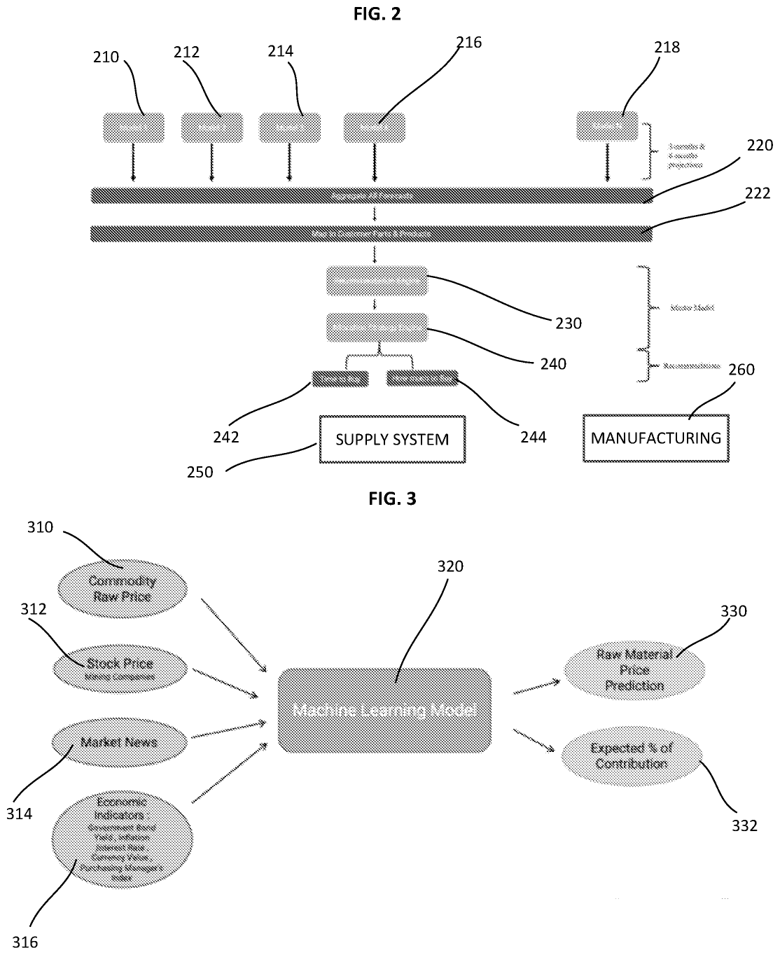

FIG. 2 shows a process flow of the example method of predicting materials and parts for a manufacturer. A set of different artificial intelligence (AI) models 210, 212, 214, 216, and 218 are each trained based on correlating different variables to each predict the price of a commodity and the availability of the commodity. A common underlying model may be trained for a specific commodity. The number of models depends on the number of materials required for the part. Each model may have a different number of input variables incorporated depending on the underlying commodity, length of historical variables, and correlation with other economic variables. This analysis may be done by the data scientist during the initial model setup. Each model 210, 212, 214, 216, and 218 in this example outputs a prediction for the respective commodity in terms of percentage of increase or decrease in supply and price expected in next 90 or 180 days. The average consumer spending on the overall part is used as input to calculate the future value of the part. Each model 210, 212, 214, 216, and 218 provides forecasts of different materials such as price forecasts and supply forecasts. Each of the forecasts are combined into an aggregated forecast 220 of a material price based on an analysis of multiple variables. The aggregation is determined by taking the average increment/decrement expected in each commodity. Multiple material projections then get mapped to a customer part that may have a specific identification such as a SKU or a manufacturer part number (MPN) (222). Then an AI based recommendation engine 230 provides output signals. The output signals are sent to allocation strategy engine 240. The outputs of the allocations strategy engine 240 include a timing output 242 that determines the time to purchase the commodity and a quantity output 244 that determines the amount to purchase to optimize production of the customer part.

In one example, the timing output 242 and quantity output 244 are provided to an automated purchasing system 250 and a manufacturing system 260. The purchasing system 250 orders the predicted materials at the designated time and quantity. The ordered materials are then delivered to the manufacturing system 260 that is controlled by the outputs to produce the customer part/SKU/MPN on a just in time basis. The timing of the manufacturing system 260 allows efficient utilization of manufacturing resources such as production equipment, energy, labor and the like based on the optimal predicted availability and price of raw materials used to manufacture the product.

The component mapping strategy is a routine to determine the commodities of a part or product. First, a user such as a customer provides a part/SKU with a corresponding bill of materials. The provided part/SKU is broken down to sub-components, homogeneous materials, and raw materials. Various techniques may be used to get this data which include but not limited to: Multi-tier Supply Chain Mapping by working directly with the suppliers of the materials in the parts. Thus, the system may be enabled for a customer to upload the product category and parts data. An operator may be authorized by the customer to contact the respective suppliers and suppliers of the supplier to access part level data. Another technique is multi-tier supply chain mapping using various data engineering and AI techniques such as collecting data from publicly available sources. Another technique is a customer providing the breakdown and material mapping for the particular part. These provide mapping between raw materials used in a Part/SKU. Thus, each product and part is mapped to its corresponding raw materials. For example, a semiconductor product is broken into the raw material level such as copper, aluminum and silicon.

The system includes an example price mapping strategy algorithm that is run by the allocation strategy engine 250. The commodities derived from the mapping are combined with the material price projection from the aggregated forecast 220. The purpose of this step is to evaluate the value at risk on the product if the price of the underlying commodity goes up or the supply of the commodity goes down. For example, if the price forecast for Copper for the next 90 days is 30% higher than current price, the user would prefer to buy the commodity today rather than wait for next 90 days. This would help them to lock a contract a better rate and also negotiate with the suppliers against the expected price fluctuation.

The following pseudo algorithm describes the master model functionality that is the aggregation of the individual models 210, 212, 214, 216, and 218. Each of the models are based on a master model architecture that employs both a quantitative and a qualitative model to predict a price or supply of the commodity. The outputs of the quantitative and qualitative models are combined to provide a forecast of the change in commodity price. Each of the models 210, 212, 214, 216, and 218 will forecast the percentage change in the price of the commodity in the next 3 months and 6 months respectively in this example. Other future periods may also be used. The inputs to the master model are the price projections from individual commodity models. These inputs are the expected percentage change in price, which could be either positive or negative. This output is multiplied by the current market price of the product to get the net change expected. Using the expected net change, the total expected change is aggregated by taking the total sum across all individual commodities to get a prediction at the part level. The algorithm will yield a buy and hold strategy as a result. The input of the predictions is then averaged across the various commodities. The weights used for the aggregation of the price are derived with the percentage of composition that is used to manufacture the component. For example, the expected composition for the final part from Copper, Aluminum and Silver are 30%, 50%, and 20% respectively. The total price of the part is $100, so the value of the Copper, Aluminum, and Silver are $30, $50, $20 respectively. Thus the net expected increase in the price of the part in next 180 days is $107.8 and in terms of percentage it is 7.8% increase.

The final weights of the price aggregation are then used to reassess the price risk or the supply risk that can be expected due to the market conditions. Using the output of the above algorithm, the time to buy, and percentage of material needed for manufacturing the product is determined.

FIG. 3 shows the inputs of an example model for a commodity such as the model 210 in FIG. 2. The model is based on several variables or inputs. In this example, the inputs include the raw price of the commodity 310 currently, the stock price of the company producing the commodity 312, market news 314, and economic indicators 316. The stock price of the company is analyzed with specific focus on companies involved in the production of the commodity in question. A positive performance of these companies, reflected in stock price increases, suggests a potential rise in demand for the corresponding commodity. Market news is monitored, paying special attention to significant events that may impact commodity production or supply. For instance, if a major event occurs in a region responsible for a significant portion of the global output of the commodity, potential price fluctuations may be anticipated in response to the major event. By combining these methods, a comprehensive understanding of the factors influencing commodity prices is gained. The economic indicators 316 may be selected based on relevance to the commodity and may include government bond yield, inflation, interest rates, currency value, and Purchasing Manager's Index (PMI). The PMI serves as an early signal of economic trends and can offer valuable information about the overall demand for commodities. When the PMI is high, indicating expansion in manufacturing activities, the PMI suggests increased demand for raw materials and commodities used in the production process. In contrast, a decline in the PMI might indicate a slowdown in manufacturing activity, potentially leading to reduced demand for commodities.

The inputs are fed into a master machine learning model 320. In this example, the machine learning model includes a qualitative model and a quantitative model based on the XGBoost algorithm, but other models with similar functionality may be used. In this example, the machine learning model 320 provides a prediction of the raw material output 330. The model 320 also outputs the expected percentage of contribution of the raw material 332 to the overall product costs.

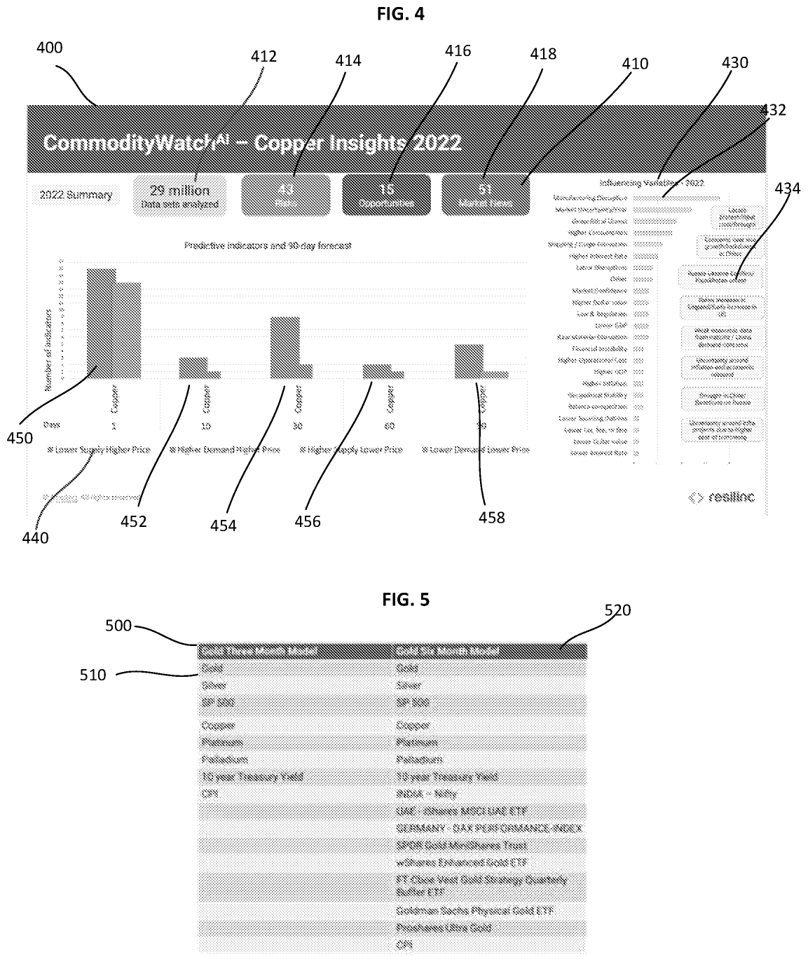

FIG. 4 is an example output display 400 for factors that have been influencing copper availability and demand. The data on the display 400 is produced from the example master architecture from the qualitative and quantitative models. The display 400 includes a summary area 410 that includes a data set field 412, a risk field 414, an opportunities field 416, and a market news field 418. The data set field 412 shows the number of data sets that are analyzed by the model. The value in the data set field 412 is the number of news feeds analyzed coming into the system through a RSS-simple web feed. The risk field 414 shows the number of risks that are output by the qualitative model. The value in the risk field 414 is the number of negative news articles with variables that can cause the price to increase. The opportunities field 416 shows the number of opportunities obtained by the qualitative model, which is the number of positive news articles with variables that can cause the price to decrease. The market news field 418 shows the number of relevant market news items derived by a natural language processing (NLP) routine performed for the qualitative model. The value in the market news field 418 is the number of relevant but neutral market news items derived by NLP for the qualitative model. These are neutral news items that are not expected to lead to any fluctuations but are good to know information relating to the commodity.

The display 400 includes an influencing variable area 430. In this example, the model has determined 38 influencing factors. The area 430 displays bars 432 representing qualitative factors that may influence future availability and price of the commodity such as copper. The bars 432 represent the number of times a variable has occurred, globally. Each bar 432 may include an information bubble 434 that includes further information that is captured by the qualitative model from analysis of news feeds. A graph area 440 displays graphs 450, 452, 454, 456, and 458 of predictions for different forecast periods. Each of the graphs 450, 452, 454, 456, and 458 include predictions in the form of four types of bars representing: 1) lower supply higher price; 2) higher demand, higher price; 3) higher supply lower price; and 4) lower demand and lower price. Each of the bars are charted in relation to the number of indicators that support the prediction. For example, in the 90 day forecast graph 458, 9 indicators support the prediction of higher demand and higher price, while 11 indicators support the prediction of lower supply higher price.

The models 210, 212, 214, 216, and 218 may include both qualitative and quantitative models. One example of a qualitative model is an AI based qualitative model such as the CommodityWatch model available from Resilinc. This model predicts fluctuations in commodity availability, prices and supply constraints based on an analyses of over 100 variables that are leading or coincidental indicators with strong correlation or causation signaling supply constraints and price fluctuations. The example model is based on annotated data going back 11 years. The annotated data identifies the market indicators that predict a change in prices for each commodity.

This is the capability of the machine learning model XGBoost. The XGBoost algorithm minimizes a specific objective function to optimize the model's performance during training. For regression tasks, the commonly used objective function is the mean squared error (MSE) or the root mean squared error (RMSE). These functions measure the average squared difference between the predicted and true target values. In the subsequent iterations, XGBoost focuses on the errors made by the previous model. XGBoost calculates the residuals (or pseudo-residuals) by taking the differences between the true target values and the predictions from the previous model. These residuals represent the part of the target variable that the model has not captured.

The next step is to fit a new weak learner (decision tree) to the residuals obtained in the previous step. This new tree aims to predict the remaining patterns and errors in the data that the previous model could not capture. Before adding the predictions of the new tree to the ensemble, XGBoost applies a regularization technique called “shrinkage” or “learning rate.” XGBoost multiplies the predictions of the new tree by a small factor (typically between 0.01 and 0.3) to control the contribution of each tree and prevent overfitting.

The predictions from the new tree are added to the predictions of the previous model. This combined prediction is used as an updated prediction of the target variable. Variable importance in XGBoost can be determined in different ways, but one common approach is based on the gain metric. Gain represents the improvement in the objective function achieved by using a particular feature in a decision tree split. A higher gain indicates that the feature is more informative for making predictions.

The steps to calculate variable importance using gain are as follows: 1) For each decision tree in the ensemble, calculate the total gain contributed by each feature across all splits where that feature is used; 2) Normalize the gains across all features to make them comparable; 3) Average the normalized gains across all decision trees in the ensemble; and 4) Rank the features based on their average normalized gains. The higher the average normalized gain, the more important the feature is for the model's predictions. XGBoost provides a built-in function to extract feature importance scores, making it easy to access this information after training the model.

Event data from news sources such as the market news input 314 provides real-time information about events and incidents that may impact product demand in the market. By monitoring news reports, businesses can identify emerging trends, consumer sentiment, and external factors influencing demand. This data can be used to adjust production volumes, marketing strategies, and distribution channels to meet changing consumer preferences and market demands. For example, a sudden spike in a GPU demand from the gaming industry can drive a shortage of semiconductor chips for automotive industry.

The availability and price fluctuations of raw materials can significantly affect a company's profitability and ability to meet consumer demands. Monitoring news sources for updates on geopolitical events, supply chain disruptions, natural disasters, and trade policies can provide valuable insights into potential raw material shortages or price hikes.

By staying informed about these trends, businesses can make proactive decisions to secure alternative suppliers, negotiate better contracts, or adjust product formulations to adapt to changing availability of raw materials. The news input 314 uses Natural Language Processing (NLP) techniques to track influencing variables that influence the availability or demand of the raw material, when they happen. The NLP models crawl over electronic news sources and other similar online sources, to identify news feeds reporting such coincident indicators with strong correlation or causation signaling supply constraints, demand fluctuations and hyper movement prices. Once this information is obtained, it is structured into a consumable format, it enables companies to take timely actions to address concerns or capitalize on positive sentiment.

Another machine learning model such as Bidirectional Encoder Representations from Transformers (BERT) offered by Resilinc classifies all news events into several categories such as Regulatory Changes, Financial News, Natural Disaster, Geopolitical and Compliance News, etc. The machine learning model then further classifies news events into positive and negative classes depending upon the news for the respective raw material. For example, a news piece stating that a particular mine, which was a leading supplier of copper in South Africa, is shut down is a negative news and this can lead to reduction in the supply of the raw material thereby increasing the price of the components. Another example may be a news item that China is reducing the quota of scrap allowed into the country. There is fear that the reduction will increase the prices of copper because 30% of copper supply in China comes from the scrap, and reduction in the quota will reduce supplies.

The example BERT machine learning model is a state-of-the-art natural language processing (NLP) algorithm developed by Google in 2018. The BERT machine learning module incorporates pre-training and transfer learning on a massive scale. BERT is based on the Transformer architecture, which was introduced in the paper “Attention Is All You Need” by Vaswani et al. in 2017. The key idea behind BERT is to leverage large-scale unsupervised pre-training on a massive corpus of text data, followed by fine-tuning on specific downstream NLP tasks.

BERT tokenizes input text into individual words or subwords using the WordPiece tokenizer. BERT breaks words into smaller subwords and assigns each subword a unique token. For example, the word “running” might be tokenized into “run” and “##ning.” The “##” prefix indicates that the token is a continuation of the previous word. Additionally, BERT uses special tokens like [CLS] and [SEP], which respectively mark the beginning and separation of sentences or input sequences.

BERT employs a deep bidirectional Transformer encoder architecture. The Transformer model consists of a stack of multiple layers, each containing self-attention mechanisms and feed-forward neural networks. The bidirectional aspect allows BERT to look at the context of a word in both directions (left and right), capturing contextual information effectively.

Pre-training of BERT involves two main tasks: masked language modeling (MLM) and next sentence prediction (NSP). In Masked Language Modeling (MLM), BERT randomly masks (replaces with [MASK] token) a certain percentage of words in the input text and then tries to predict those masked words based on the context of the surrounding words. This process helps BERT learn deep bidirectional representations as it needs to understand the context to predict the masked words correctly. In Next Sentence Prediction (NSP), BERT also predicts whether a pair of sentences follow each other in the original text or if they are randomly paired sentences. This task aids the model in understanding the relationship between two sentences and enables it to perform better in tasks that involve sentence-level reasoning.

BERT is pre-trained on a massive amount of text data collected from the internet, containing billions of words. The large-scale corpus helps the model capture diverse language patterns and improves its generalization to various NLP tasks. After pre-training on the large corpus, BERT is fine-tuned on specific downstream NLP tasks such as text classification, named entity recognition, question answering, and more. During fine-tuning, a task-specific layer is added on top of BERT's pre-trained layers, and the whole model is fine-tuned using labeled data from the specific task.

The output layer of BERT can be adapted for different NLP tasks. For instance, for text classification tasks, the output of the [CLS] token is used as input to a softmax layer for classification. One of the main strengths of BERT is its ability to generate contextualized word representations. This means that the representation of a word depends not only on the word itself but also on its context in the sentence. This is achieved through the self-attention mechanism in the Transformer, which allows BERT to focus on different parts of the input sentence while encoding it.

To use BERT for sentiment analysis for the example system, a dataset of market news was labeled with sentiments (positive, negative, or neutral) manually. The data is then split it into training and testing sets. First, the news text was mapped into BERT input format by tokenizing, padding, and adding special tokens like [CLS] and [SEP]. Second, a classification layer was added on top of the pre-trained BERT model. This layer is a simple neural network that takes the output representation of the [CLS] token from BERT and maps it to a binary sentiment score (positive or negative). Third, the entire model was fine-tuned on the labeled dataset using binary cross-entropy loss. The fine-tuning process updates the weights of the model to make the model specialized for the sentiment analysis task.

The example machine learning model 320 is trained to identify patterns and verifications based on analyzing multiple datasets indicating directional movement as much as 90 days, 30 days or 10 days ahead of time.

An example of a quantitative model is the CommodityWatch AI Quant Price Forecast available from Reslinic. The quantitative model uses advanced AI based analytics to predict fluctuations in commodity prices based on an analysis of over 800+ economic and other quantitative factors. The carefully constructed quantitative models based on XGBoost in this example make future predictions in commodity prices for up to a 6-month time horizon.

In this example, different futures contract price traded on exchanges along with the most correlated assets/securities/ETFs and other instruments are used to understand the movement of the underlying security. For example, gold may be a commodity with a model having different input features determined as explained above.

FIG. 5 is a table 500 shows a list of the features used in an example model for forecasts of gold. In this example, a first column 510 shows features for input into the example gold 3 month model. A second column 520 shows features for input into the example gold 6 month model. Once the technical features are created in table 500, the inputs are passed to the model to output the predicted prices and availability.

The example process in FIG. 2 may use customized technical indicators for the models. The custom technical indicators are ensembled with standard technical indicators such as exponential moving average, PVI, and NVI. The ensemble creates strong indicators which are useful in predicting longer horizon price projections.

The overall algorithm finds extreme points and then finds top prices. In relation to finding extremes, the main objective function is to identify the extreme points in the data in both directions. Instead of using the standard maxima and minima objective functions to get the top values in both end points, the derivative of the series is used at various magnitudes to the extreme values.

The increment-based time series for the input is obtained. This is done by taking the price from an exchange board that is updated daily during the weekdays. As each day is over, the time series is incremented. The first and second derivative of the series is calculated based on original time series. For each value in the first derivative, if the value of the slope is equal to 0 for a specific index, either the slope is 0 or it crosses from positive to negative with a value closer to 0.

The pseudo algorithm for finding extreme points is as follows:
If the value of the first derivative at index ‘i’ is greater than 0 and the value at ‘i+1’ is less than 0, the main value series have decreasing order or value of derivative at I (dummy variable used to indicate position of a value in the code) is less than 0 and value at i+1 is greater than 0 with series taking opposite positions. This is stored as condition 1;
The same operation is performed but with the comparison of I & i−1 and stored as condition 2;
If both conditions are met, the indices of both the first and second derivatives with min id & max id are obtained;
These extremes ids are passed to the next function.

The find top prices function, employs the extreme values previously obtained from the extreme values function to create features to signal the positive and negative trends. The main objective of this function is to get the top prices that have high severity compared to other data points.

The pseudo algorithm for finding top prices is as follows:
the data points are sorted in ascending order for high value points and descending order for low value points;
For each of the elements in the sorted values, the absolute percentage of change in the data points is calculated. The function gives the ability to change the rank of the order of price points based on the threshold;
Keeping the threshold high, lower yield of ranks is obtained and higher yield of rnaks is obtained by keeping the threshold low;
Store the indices of high points and take the top n values as high and low points respectively;
take the index of these high & low points for further processing to the next stage; and
the parameters of the thresholds are decided by cross validation.

In order to cross check the importance of the features that are built, the indicators data is passed into a Principal Component Analysis (PCA) algorithm. The principal components of a collection of points in a real coordinate space are a sequence of p unit vectors, where the i-th vector is the direction of a line that best fits the data while being orthogonal to the first i−1 vectors. Here, a best-fitting line is defined as one that minimizes the average squared distance from the points to the line. These directions constitute an orthonormal basis in which different individual dimensions of the data are linearly uncorrelated. Principal component analysis is the process of computing the principal components and using them to perform a change of basis on the data, sometimes using only the first few principal components and ignoring the rest. This algorithm is used in dimensionality reduction and making predictive models.

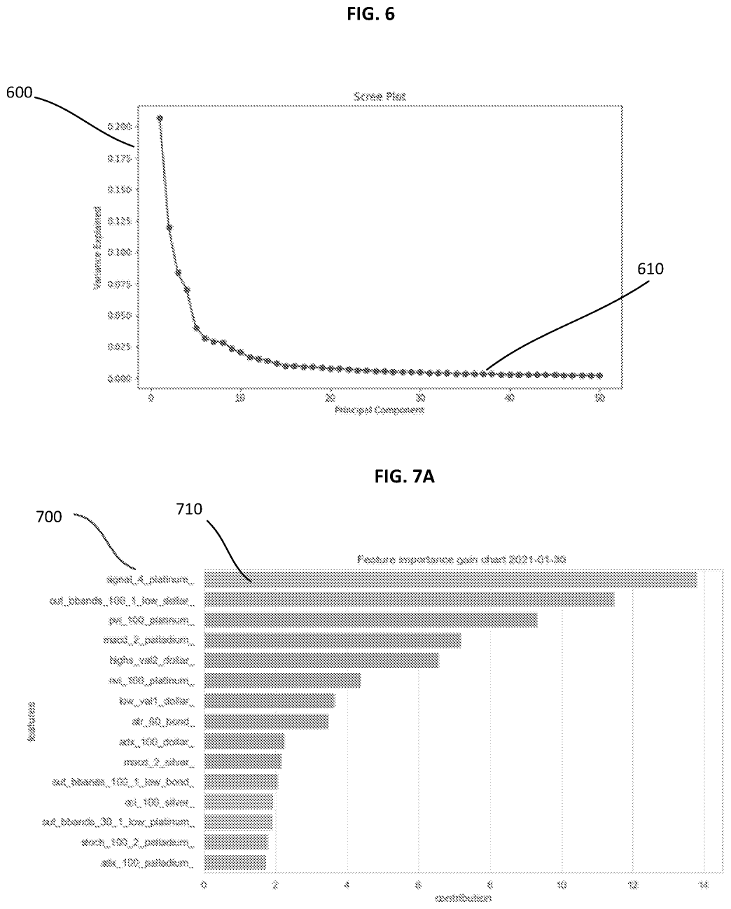

FIG. 6 shows a graph 600 that plots an example of the results of the PCA component analysis applied to the analysis of gold in the example above. The graph 600 plots the principal component against variance in a plot 610. PCA is a dimensionality reduction technique that transforms the original variables into a new set of uncorrelated variables called principal components. These components are ordered in terms of their ability to explain the most variance in the data, with the first component explaining the most variance, the second component explaining the second most, and so on. The graph 600 helps understand how much variance each principal component captures and how many principal components are needed to retain a certain proportion of the total variance in the data.

In this example, a list of features included in the top 10 components of an example part are ranked according to the eigen values. eigenvalues are ranked to determine the importance of each principal component. Eigenvalues represent the amount of variance explained by each principal component. The larger the eigenvalue, the more variance that component explains, and thus, it is considered more important in capturing the underlying structure of the data. In this example, gold as a commodity is used to back test and measure performance of the algorithm. Back testing is a process of measuring the performance of model forecast for past data by changing the components one by one to measure which combination gives the best result.

In the next step, the data is passed into an ensembled decision tree model. The objective of this step is to create decision tree regression model to get expected change in the price of the asset in a longer time horizon.

The features are then evaluated to determine the respective importance in prediction of change. In this example, the evaluation is performed by an example XGBoost decision tree model. XGBoost is a gradient based decision tree model which uses sequential recursive tree building to get predictions which are averaged over across the trees. Gain is used as metric to measure the importance of each feature to understand how important these features are to predict the change.

The gain implies the relative contribution of the corresponding feature to the model and is calculated by taking the contribution of each feature for each tree in the model. A higher value of this metric when compared to another feature implies it is more important for generating a prediction. The average training loss reduction gained when using a feature for splitting.

In an example, model the number of trees was 500, the depth of the tree was 5, and the booster method was the gbtree routine. The gbtree routine is the default booster method used in XGBoost for both regression and classification tasks. XGBoost builds an ensemble of decision trees to create the final predictive model. In the gbtree routine, the weak learners are decision trees, which are hierarchical structures used for making predictions by recursively partitioning the feature space. Each tree is trained to correct the errors made by the previous trees, gradually improving the model's predictions. The gradient boosting part of the gbtree routine refers to the technique of sequentially training new trees to minimize the errors (residuals) of the previous model. In each iteration, the model fits a new decision tree to the negative gradient (residuals) of the loss function, with respect to the previous model's predictions. This process efficiently combines multiple trees to create a powerful ensemble model.

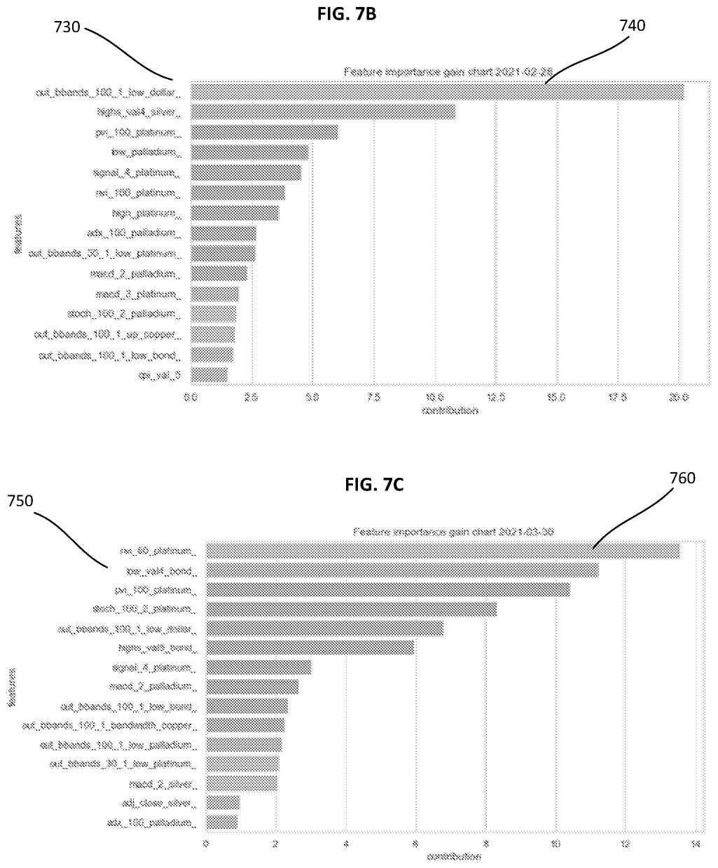

FIG. 7A is a chart 700 that shows that the importance ranked features in the higher orders in its calculations for predictions based on the example model. In this example, each of the bars 710 corresponding to a feature are plotted based on a contribution value by the XGBoost model. The bars are ordered in terms of the determined importance of the corresponding feature in predictions for a certain period. Thus, the signal 4 platinum indicator is the most important feature for gold for a certain first monthly time period. FIG. 7B shows a chart 730 that shows the ranked features in bars 740 for gold for a second monthly time period. FIG. 7C shows a chart 750 that shows the ranked features in bars 760 for gold for a third monthly time period.

The trained model is passed into a Shapley algorithm to check the consistency of the feature importance. The custom features are still in the top features list. The Shapley method is mathematically equivalent to averaging differences in predictions over all possible orderings of the features, rather than just the ordering specified by their position in the tree. The resulting drop in accuracy of the model when a single feature is randomly permuted in the test data set is used to determine the importance of a feature.

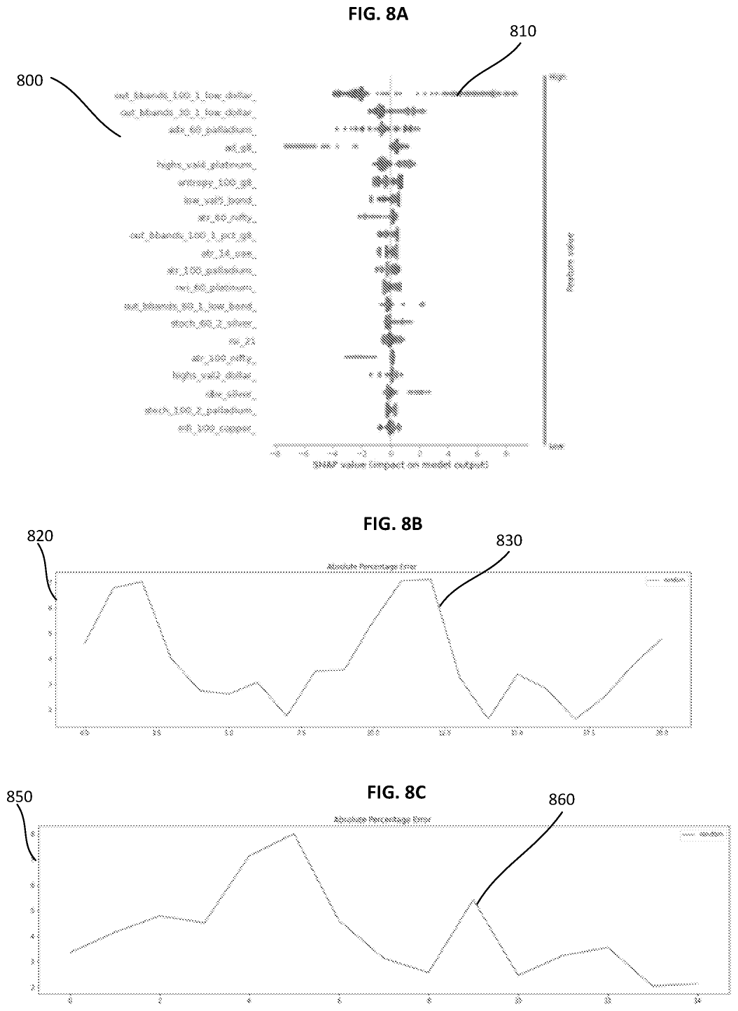

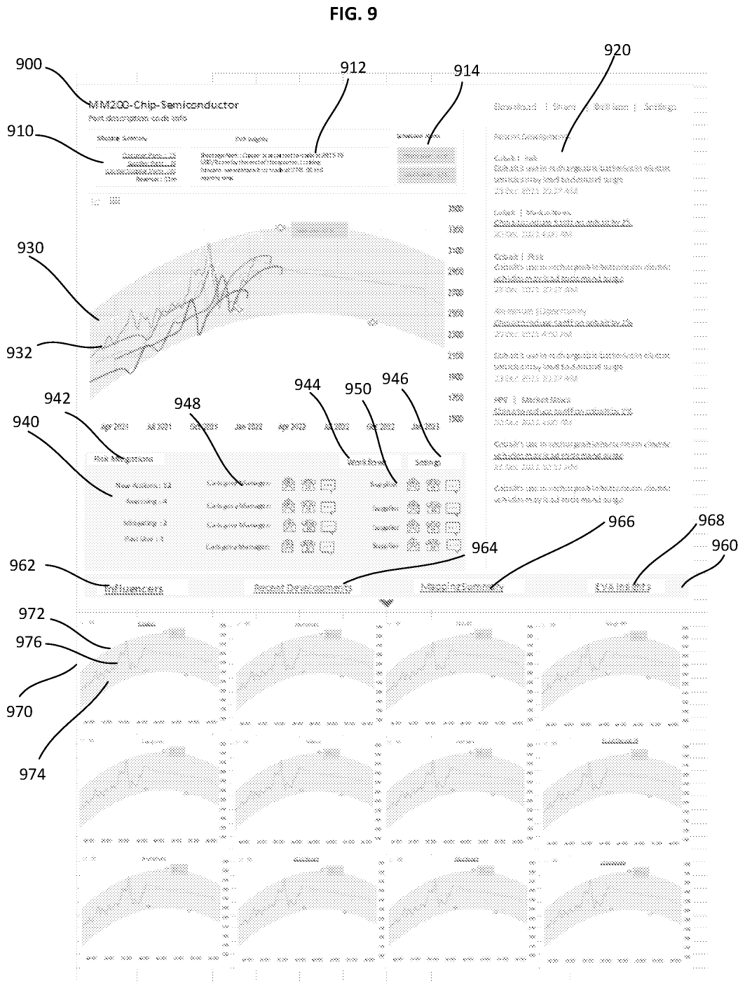

FIG. 8A shows a graph 800 of the attribution of custom features for an example 6-month model using random sampling of time frame. The graph 800 plots each of the custom features based on the determined Shapley values. A Shapley chart is created to visually represent the contribution of each feature. The chart typically consists of a horizontal bar plot, where each feature is represented by a bar 810. The length of the bar indicates the magnitude of the feature's Shapley value, which represents its contribution to the model's prediction for the data point of interest. The bars may be color-coded to indicate the direction of the contribution. For example, positive Shapley values may be plotted in one color (e.g., blue) to indicate features that positively influence the prediction, while negative Shapley values may be shown in another color (e.g., red) to indicate features that have a negative impact on the prediction.

The example model predicts the expected change in the price of the asset as a percentage of change in the movement of underlying commodity. The average absolute change in the difference of actual change and forecasted change is checked.

FIG. 8B is a chart 820 describing the performance of the example 3-month model. FIG. 8C is a chart 850 describing the performance of the example 6-month model. The charts 820 and 850 include a respective plot 830 and 860 that plot the absolute percentage of error against the number of months.

In this example, the model constantly retrains itself every two weeks to ingest the latest data into its system and also understand the pattern of change in price and supply data from t66-t0 (days), to calculate the change in predicted versus actual price change and supply change. Of course other intervals for retraining may be selected depending on the volatility of different commodities. Hyperparameter tuning is achieved using the auto tune library, hyperopt, and to adjust the threshold to achieve maximum accuracy. A typical data batch for backtesting of accuracy measurement is obtained from data measured previously from 12-15 months.

In this example, the example machine learning algorithm, XGBoost, is designed to bolster the efficiency and accuracy of the example process. In this example, the machine learning algorithm is powered by an MLOps system on a trusted AWS Cloud platform. The data protection layer utilizes the capabilities of AWS Cloud for robustness and security.

The recommendation algorithm of the recommendation engine 230 in FIG. 2 intakes the predictions from the previous machine learning models to transform the expected percentage change forecast and into action points. The Pseudo Algorithm of the recommendation algorithm is as follows:
a sequence of 10 days forecast from the machine learning model is taken, the data is applied into function called Bollinger bands;
the rolling mean and rolling standard deviation with a constant rate of 10 days is taken;
the input of the rolling mean is added and subtracted to the product of twice of the standard deviation to calculate the top and bottom bands of the forecast;
When the next forecast comes up for the next day, this value is compared with the both the upper and lower bands
If the new forecast value is less than or equal to Bollinger lower band and the direction of the forecast is less than equal to 0 then the recommendation value is assigned as Strong hold
If the new forecast value is greater than or equal to Bollinger upper band and the direction of the forecast is greater than equal to 0 then the recommendation value is assigned as Strong buy
If both of the above conditions are not met and the new value is between both the bands then, the recommendation is classified as Buy or Hold based on the direction of the prediction.

FIG. 9 is an example output display 900 of the data of the recommendation engine 230 in FIG. 2. The display 900 shows an example semiconductor part/SKU and supply data loaded by a semiconductor manufacturer into the example system. The example semiconductor part/SKU is mapped to several key raw materials shown as influencers. The display includes a mapping summary area 910, an EVA insights area 912, and a scheduled alerts area 914. A recent developments area 920 contains different alerts in relation to news relating to potential risks, opportunities, and opportunities. Each of the categories may be color coded, for example risks may be color coded as red, opportunities color coded as green, and market news color [coded as blue. A predicted price chart 930 includes different trend lines 932 of raw price in the market for each of the critical raw materials for the example product over a time scale.

A risk mitigation window 940 allows a user to take different actions to address different risks. In this example, an administrator creates actions for category managers. Actions are pre-created steps that are automatically assigned within the playbook. An example action may be to check on an inventory clause and how much inventory a supplier holds, then plan on renegotiating the contract due to a sudden price decrease. The risk mitigation window 940 includes a risk mitigations selection 942, a workflows selection 944, and a setting selection 946. The risk mitigations selection 942 will display a list of actions. The workflows selection 944 is selected and thus data on the status of current actions is shown. The settings selection 946 allows a user to configure the interface in relation to actions. The window 940 includes a list of category managers 948 and a list of suppliers 950. Each category manager and supplier in the lists 948 and 950 have icons representing different methods such as email, phone or text message to contact the manager or supplier. Selection of one of the icons selects an input to initiate a communication via the respective method to contact the manager or supplier via the computer device that displays the output display 900.

In this example, since the workflows selection 944 has been selected, the window 940 includes a summary of currently pending actions. The new action number is the number of the actions currently pending. The assessing number indicates the actions that are being assessed but no decision has been made. The mitigating is the number of actions where the action will require mitigation. Past due indicates the number of actions that are late.

A selection menu 960 includes an influencers option 962, a recent developments option 964, a mapping summary option 966, and an EVA insights option 968. The recent developments option 964 when selected causes different news items selected by the NLP to be shown. Selecting the mapping summary option 966 causes the mapping between the part and the raw materials to be updated. The breakdown of materials that are critical for a component. Mapping allows linking materials to components. In this example, 12 materials are linked to a semiconductor component. Forecast from individual materials are aggregated. In this example, the system operator has component BOM information which links components to parts used in component, and location of suppliers where the parts come from. The BOM information also goes several tiers deep and links sub-tier suppliers that supplies subcomponents to main component from sites. As soon as material is linked to the main component, detailed visibility into sub-tiers data is available.

Selecting the EVA insights option 968 causes recommendations of when to invest in longer-term contracts, when to initiate contract renewals to be shown based on aggregated projections. In this example, the influencers option 952 is selected and a set of graphs 970 is shown for each of the influencers.

The trend lines 932 of the predicted price chart 930 are predicted price lines from the models for the raw materials linked to a part. The example system compares historic fluctuations in raw materials with fluctuations in the availability and prices of the part/SKU. Based on that analysis, the system determines raw materials that, historically, have influenced the availability and price of the example semiconductor part/SKU. As explained above, the mapping engine 222 links the raw materials to the example semiconductor Part/SKU. By linking the materials, a customer can now monitor raw material projections at the part/SKU level. The price chart 930 of the output display 900 allows an aggregated price prediction for every material that is linked to the example part. This provides an aggregated trend to the customer for the part/SKU material cost.

The recent developments are 920 shows the risks and opportunities highlighted by the quantitative models as explained above. The graphs 970 provide projections of individual materials. For example, one graph 972 plots prediction for copper. A shaded area 974 indicates the upper and lower band in which the price of the commodity will lie. A middle line 976 indicates the actual price forecast. On a given day the price of copper will lie within the two shaded bands. In this example, there are 12 critical materials and thus 12 graphs are displayed.

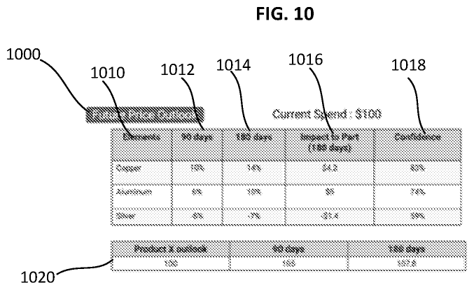

FIG. 10 is an example output table 1000 that shows the future price outlook for 3 example commodities. The table lists elements or materials required for a product in a first column 1010. A second column 1012 shows the expected percentage change price forecast for 90 days and a third column 1014 shows the expected percentage change price forecast for 180 days. A fourth column 1016 shows the impact to the part in cost over 180 days. A fifth column 1018 shows the confidence of the prediction. The confidence is calculated by using the average 6 month model performance is correctly predicting the direction of the price of the commodity. For example, if the model predicted the direction correctly 8 times out of 10 samples, then the confidence is 80%. The table 1000 also includes an overall product outlook row 1020 that forecasts the outlook over 90 days and 180 days. The outlook row 1020 lists the final prices for 90 and 180 days respectively. The outlook row 1020 thus provides a summation of the impact to a part at a commodity level by considering the price change of a commodity on the total change in the part price.

The example method and system thus provides a model to map material forecasts to a specific product. The system and method automates predictions of changing prices of key materials over three to six months or other periods of time. Such materials include but are not limited to, precious metals, copper, aluminum, rare earth elements, chemicals, paper, etc., Price change predictions indicate both directions, up/down/no change, and magnitude or percentage change compared to the price on the day of prediction. The system may make similar predictions of the supply or availability of these materials.

The example system may deconstruct any part, chemical, material, etc. (Manufacturer Part Number or MPN) used in supply chain operations into component raw materials. By applying the predictions, the example system may predict how the aggregate cost of the MPN will change in three to six months in both direction and magnitude. By combining that prediction with the current inventory of MPN and finished products on hand, and the product demand forecast, the example system can recommend when and how many MPNs to purchase. The results may be used to control an automatic purchasing system to purchase and schedule delivery of the materials to a manufacturing system.

The example system can review historic spend patterns and compare fluctuations in spend with fluctuations in historic commodity prices. Then, by analyzing the commodity weightages, the system can identify materials that influence the MPN costs directly or indirectly. The example system can also help customers rank suppliers in terms of fair engagement and pricing such as from the data from FIG. 10 based on the forecast price of commodities.

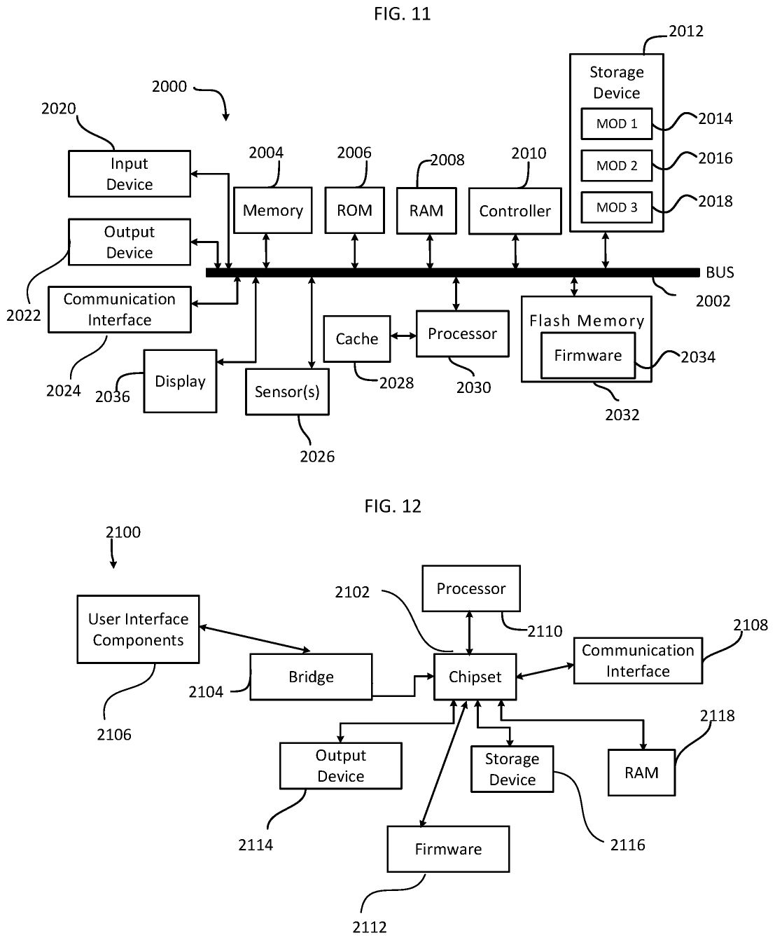

FIGS. 11-12 illustrate an example computing system 2000, in which the components of the computing system are in electrical communication with each other using a bus 2002. The system 2000 includes a processing unit (CPU or processor) 2030 and a system bus 2002 that couple various system components, including the system memory 2004 (e.g., read only memory (ROM) 2006 and random access memory (RAM) 2008), to the processor 2030. The system 2000 can include a cache of high-speed memory connected directly with, in close proximity to, or integrated as part of the processor 2030. The system 2000 can copy data from the memory 2004 and/or the storage device 2012 to the cache 2028 for quick access by the processor 2030. In this way, the cache can provide a performance boost for processor 2030 while waiting for data. These and other modules can control or be configured to control the processor 2030 to perform various actions. Other system memory 2004 may be available for use as well. The memory 2004 can include multiple different types of memory with different performance characteristics. The processor 2030 can include any general purpose processor and a hardware module or software module, such as module 1 2014, module 2 2016, and module 3 2018 embedded in storage device 2012. The hardware module or software module is configured to control the processor 2030, as well as a special-purpose processor where software instructions are incorporated into the actual processor design. The processor 2030 may essentially be a completely self-contained computing system that contains multiple cores or processors, a bus, memory controller, cache, etc. A multi-core processor may be symmetric or asymmetric.

To enable user interaction with the computing device 2000, an input device 2020 is provided as an input mechanism. The input device 2020 can comprise a microphone for speech, a touch-sensitive screen for gesture or graphical input, keyboard, mouse, motion input, and so forth. In some instances, multimodal systems can enable a user to provide multiple types of input to communicate with the system 2000. In this example, an output device 2022 is also provided. The communications interface 2024 can govern and manage the user input and system output.

Storage device 2012 can be a non-volatile memory to store data that is accessible by a computer. The storage device 2012 can be magnetic cassettes, flash memory cards, solid state memory devices, digital versatile disks, cartridges, random access memories (RAMs) 2008, read only memory (ROM) 2006, and hybrids thereof.

The controller 2010 can be a specialized microcontroller or processor on the system 2000, such as a BMC (baseboard management controller). In some cases, the controller 2010 can be part of an Intelligent Platform Management Interface (IPMI). Moreover, in some cases, the controller 2010 can be embedded on a motherboard or main circuit board of the system 2000. The controller 2010 can manage the interface between system management software and platform hardware. The controller 2010 can also communicate with various system devices and components (internal and/or external), such as controllers or peripheral components, as further described below.

The controller 2010 can generate specific responses to notifications, alerts, and/or events, and communicate with remote devices or components (e.g., electronic mail message, network message, etc.) to generate an instruction or command for automatic hardware recovery procedures, etc. An administrator can also remotely communicate with the controller 2010 to initiate or conduct specific hardware recovery procedures or operations, as further described below.

The controller 2010 can also include a system event log controller and/or storage for managing and maintaining events, alerts, and notifications received by the controller 2010. For example, the controller 2010 or a system event log controller can receive alerts or notifications from one or more devices and components, and maintain the alerts or notifications in a system event log storage component.

Flash memory 2032 can be an electronic non-volatile computer storage medium or chip that can be used by the system 2000 for storage and/or data transfer. The flash memory 2032 can be electrically erased and/or reprogrammed. Flash memory 2032 can include EPROM (erasable programmable read-only memory), EEPROM (electrically erasable programmable read-only memory), ROM, NVRAM, or CMOS (complementary metal-oxide semiconductor), for example. The flash memory 2032 can store the firmware 2034 executed by the system 2000 when the system 2000 is first powered on, along with a set of configurations specified for the firmware 2034. The flash memory 2032 can also store configurations used by the firmware 2034.

The firmware 2034 can include a Basic Input/Output System or equivalents, such as an EFI (Extensible Firmware Interface) or UEFI (Unified Extensible Firmware Interface). The firmware 2034 can be loaded and executed as a sequence program each time the system 2000 is started. The firmware 2034 can recognize, initialize, and test hardware present in the system 2000 based on the set of configurations. The firmware 2034 can perform a self-test, such as a POST (Power-On-Self-Test), on the system 2000. This self-test can test the functionality of various hardware components such as hard disk drives, optical reading devices, cooling devices, memory modules, expansion cards, and the like. The firmware 2034 can address and allocate an area in the memory 2004, ROM 2006, RAM 2008, and/or storage device 2012, to store an operating system (OS). The firmware 2034 can load a boot loader and/or OS, and give control of the system 2000 to the OS.

The firmware 2034 of the system 2000 can include a firmware configuration that defines how the firmware 2034 controls various hardware components in the system 2000. The firmware configuration can determine the order in which the various hardware components in the system 2000 are started. The firmware 2034 can provide an interface, such as an UEFI, that allows a variety of different parameters to be set, which can be different from parameters in a firmware default configuration. For example, a user (e.g., an administrator) can use the firmware 2034 to specify clock and bus speeds, define what peripherals are attached to the system 2000, set monitoring of health (e.g., fan speeds and CPU temperature limits), and/or provide a variety of other parameters that affect overall performance and power usage of the system 2000. While firmware 2034 is illustrated as being stored in the flash memory 2032, one of ordinary skill in the art will readily recognize that the firmware 2034 can be stored in other memory components, such as memory 2004 or ROM 2006.

System 2000 can include one or more sensors 2026. The one or more sensors 2026 can include, for example, one or more temperature sensors, thermal sensors, oxygen sensors, chemical sensors, noise sensors, heat sensors, current sensors, voltage detectors, air flow sensors, flow sensors, infrared thermometers, heat flux sensors, thermometers, pyrometers, etc. The one or more sensors 2026 can communicate with the processor, cache 2028, flash memory 2032, communications interface 2024, memory 2004, ROM 2006, RAM 2008, controller 2010, and storage device 2012, via the bus 2002, for example. The one or more sensors 2026 can also communicate with other components in the system via one or more different means, such as inter-integrated circuit (I2C), general purpose output (GPO), and the like. Different types of sensors (e.g., sensors 2026) on the system 2000 can also report to the controller 2010 on parameters, such as cooling fan speeds, power status, operating system (OS) status, hardware status, and so forth. A display 2036 may be used by the system 2000 to provide graphics related to the applications that are executed by the controller 2010.

FIG. 12 illustrates an example computer system 2100 having a chipset architecture that can be used in executing the described method(s) or operations, and generating and displaying a graphical user interface (GUI). Computer system 2100 can include computer hardware, software, and firmware that can be used to implement the disclosed technology. System 2100 can include a processor 2110, representative of a variety of physically and/or logically distinct resources capable of executing software, firmware, and hardware configured to perform identified computations. Processor 2110 can communicate with a chipset 2102 that can control input to and output from processor 2110. In this example, chipset 2102 outputs information to output device 2114, such as a display, and can read and write information to storage device 2116. The storage device 2116 can include magnetic media, and solid state media, for example. Chipset 2102 can also read data from and write data to RAM 2118. A bridge 2104 for interfacing with a variety of user interface components 2106, can be provided for interfacing with chipset 2102. User interface components 2106 can include a keyboard, a microphone, touch detection, and processing circuitry, and a pointing device, such as a mouse.

Chipset 2102 can also interface with one or more communication interfaces 2108 that can have different physical interfaces. Such communication interfaces can include interfaces for wired and wireless local area networks, for broadband wireless networks, and for personal area networks. Further, the machine can receive inputs from a user via user interface components 2106, and execute appropriate functions, such as browsing functions by interpreting these inputs using processor 2110.

Moreover, chipset 2102 can also communicate with firmware 2112, which can be executed by the computer system 2100 when powering on. The firmware 2112 can recognize, initialize, and test hardware present in the computer system 2100 based on a set of firmware configurations. The firmware 2112 can perform a self-test, such as a POST, on the system 2100. The self-test can test the functionality of the various hardware components 2102-2118. The firmware 2112 can address and allocate an area in the memory 2118 to store an OS. The firmware 2112 can load a boot loader and/or OS, and give control of the system 2100 to the OS. In some cases, the firmware 2112 can communicate with the hardware components 2102-2110 and 2114-2118. Here, the firmware 2112 can communicate with the hardware components 2102-2110 and 2114-2118 through the chipset 2102, and/or through one or more other components. In some cases, the firmware 2112 can communicate directly with the hardware components 2102-1410 and 2114-2118.

It can be appreciated that example systems 2000 (in FIG. 11) and 2100 can have more than one processor (e.g., 2030, 2110), or be part of a group or cluster of computing devices networked together to provide greater processing capability.

As used in this application, the terms “component,” “module,” “system,” or the like, generally refer to a computer-related entity, either hardware (e.g., a circuit), a combination of hardware and software, software, or an entity related to an operational machine with one or more specific functionalities. For example, a component may be, but is not limited to being, a process running on a processor (e.g., digital signal processor), a processor, an object, an executable, a thread of execution, a program, and/or a computer. By way of illustration, both an application running on a controller, as well as the controller, can be a component. One or more components may reside within a process and/or thread of execution, and a component may be localized on one computer and/or distributed between two or more computers. Further, a “device” can come in the form of specially designed hardware, generalized hardware made specialized by the execution of software thereon that enables the hardware to perform specific function, software stored on a computer-readable medium, or a combination thereof.

Each of these embodiments and obvious variations thereof is contemplated as falling within the spirit and scope of the claimed invention, which is set forth in the following claims.

What is claimed is:

1. A method of predicting pricing of a product, comprising:
collecting data related to the price of each of a plurality of materials required for the product over a predetermined period of time;
predicting the price of each of the plurality of materials at a future time based on inputting the collected data to a plurality of models executed by a processor;
aggregating the predicted changes in prices of the plurality of materials to determine the aggregated predicted cost of the product at a period of time in the future; and
producing a recommendation of obtaining a plurality of materials to meet a future demand based on the predicted aggregated changes in prices.

2. The method of claim 1, wherein each of the plurality of models includes a qualitative model analyzing qualitative data inputs and a quantitative model analyzing quantitative data inputs.

3. The method of claim 2, wherein analyzing quantitative data includes applying a natural language process to the text of news articles to determine an effect on the predicted price.

4. The method of claim 1, wherein the prediction outputs include availability of each of the plurality of materials.

5. The method of claim 1, further comprising deconstructing the product into the different plurality of materials.

6. The method of claim 1, wherein an aggregated product cost is determined by determining the weight of each of the materials based on predicted material cost.

7. The method of claim 1, further comprising automatic communication of an order for at least one of the materials based on the recommendation.

8. The method of claim 1, further comprising ranking the plurality of materials by influence on the product production.

9. The method of claim 1, further comprising scheduling a manufacturing system to produce the product based on the resulting output.

10. The method of claim 1, further comprising displaying on a display an interface with the predicted prices of each of the plurality of materials and providing a communication input to contact a supplier of at least one of the plurality of materials.

11. A system comprising:
a memory; and
a controller including one or more processors, the controller operable to:
determine a plurality of materials necessary to manufacture a product;
collect data related to the price of each of a plurality of materials required for the product over a predetermined period of time;
predict the price of each of the plurality of materials at a future time based on the collected data via a plurality of models;
aggregate the prices to determine the aggregate predicted cost of the product at a period of time in the future; and
produce a recommendation of the materials to meet a future product demand based on the predicted cost.

12. The system of claim 11, wherein each of the plurality of models includes a qualitative model analyzing qualitative data inputs and a quantitative model analyzing quantitative data inputs.

13. The system of claim 12, wherein analyzing quantitative data inputs includes applying a natural language processor to the text of news articles to determine an effect on the predicted price.

14. The system of claim 11, wherein the prediction outputs include availability of each of the plurality of materials.

15. The system of claim 11, wherein an aggregated product cost is determined by determining the weight of each of the materials based on predicted material cost.

16. The system of claim 11, further comprising an interface coupled to a supply system, wherein the controller is operable to automatically communicate an order on the interface for at least one of the materials based on the recommendation.

17. The system of claim 11, wherein the controller is operable to rank the plurality of materials by influence on the product production.

18. The system of claim 11, further comprising a manufacturing system coupled to the controller, wherein the controller is operable to schedule the manufacturing system to produce the product based on the recommendation.

19. The system of claim 1, further comprising a display coupled to the controller, the controller operable to display an interface with the predicted prices of each of the plurality of materials and provide a communication input to contact a supplier of at least one of the plurality of materials.

20. A non-transitory computer-readable medium having machine-readable instructions stored thereon, which when executed by a processor, cause the processor to:
determine a plurality of materials necessary to manufacture a product;
collect data related to the price of each of a plurality of materials required for the product over a predetermined period of time;
predict the price of each of the plurality of materials at a future time based on the collected data via a plurality of models;
aggregate the prices to determine the aggregate predicted cost of the product at a period of time in the future; and
produce a recommendation of the materials to meet a future product demand based on the predicted cost.
